(19) United States
(12) Patent Application Publication
(10) Pub. No.: US 2013/0302486 A1
(43) Pub. Date: Nov. 14, 2013

(54) MOULDED RECEPTACLE FOR DRUPES, SUCH AS OLIVES, AND METHOD AND DEVICE FOR AUTOMATICALLY PITTING AND/OR FILLING THE DRUPES USING THE MOULDED RECEPTACLE

(71) Applicant: Harry IMHOF, Taegerwilen (CH)

(72) Inventor: Harry IMHOF, Taegerwilen (CH)

(21) Appl. No.: 13/855,758

(22) Filed: Apr. 3, 2013

Related U.S. Application Data
(63) Continuation of application No. PCT/IB2011/054066, filed on Sep. 16, 2011.

(30) Foreign Application Priority Data
Oct. 6, 2010 (DE) 10 2010 038 025.3

(51) Int. Cl. A23P 1/08

(52) U.S. Cl. CPC A23P 1/087
USPC 426/282; 99/516; 99/517

(57) ABSTRACT

In a holding mold part for drupes, particularly for holding olives for their treatment, such as pickling, pitting, filling, and the like, which can be put together, in centered manner, from an upper part and a lower part, and between which parts multiple cavity sections that complement one another for holding the olives are situated in the mold part, at least the cavity sections in the upper part are configured by a flexible end as part of a clamped film insert, to compensate for different natural lengths of the raw olives to be treated. Furthermore, a method simultaneously treats multiple olives, from their raw state to the filled end product, and a device for this purpose has multiple work stations, wherein the holding mold part can be used not only in the method but also in the device.

The invention relates to a holding mold part for drupes, particularly for holding raw olives for their treatment, such as pickling, pitting, and the like, as well as to a method that can be carried out with this holding mold part, and a device for this purpose, for optional pickling, pitting, filling, and unmolding of the olives. In this connection, other possible drupes are cherries, apricots, peaches, etc.

In this connection, a device for automatic filling of olives that have already been pitted, with a meat paste, is known from EP 0 490 843 A1, which device has a holding mold part for holding the already pitted olives and for their treatment, which part can be put together from a lower part and an upper part, between which multiple cavity sections for the olives, which complement one another, are proceed. In this connection, the cavity sections form pockets for holding the olives, of which pockets multiple ones are provided on the circumference of a wheel-shaped support, at equal distances from one another. To fill the individual olives, these are slit open and then the meat paste is injected into them. However, in the case of this device, the holding capacity with regard to the number of olives and thus their throughput is limited by the peripheral arrangement of the individual olives. Also, the diameter of the wheel-shaped support cannot be increased in just any desired manner to increase the throughput, because otherwise, this device becomes too cumbersome.

Furthermore, what is called a drum pitting method, for example, is known for pitting of raw olives, in which method olives that have already been sorted are cycled into a feed belt by way of a mass funnel, and this belt then conveys the olives to a rotational ejector drum, whereby the olives, which are thereby pitted, can also be optionally filled or stuffed during the same process. In the case of this method or of this device, the olive pits are removed using tappets that are confirmed by means of a mechanical cam control. It is true that such rotational ejector drums operate in cost-advantageous manner due to their relatively simple structure, but this is offset by a relatively high rejects rate of 8% to 12%.

In this connection, this high rejects rate results from the total of the tolerances that are added up, for example caused by the imprecise longitudinal axis positioning of the olives, the transport paths of the olives, and the pit ejection principle itself.

Also, what is called an individual pitting station is known, with which raw olives can be pitted practically manually, individually, according to the piercing principle. In this connection, the olives are laid by hand into a support mold, and pushed into a drop tube from there, by means of a tappet, from which tube the olives then drop, in each instance, into a mold strip having multiple cavities for holding them, which strip is then pushed manually, from olive to olive, underneath an ejector having a cutting blade for removing the olive pit, in each instance. Such an individual pitting station not only works relatively imprecisely with regard to a loss of fruit flesh, but is also unsuitable for industrial pitting of large amounts of olives.

An olive pitting apparatus is known from U.S. Pat. No. 2,360,103 A, by means of which olives are pitted automatically. For this purpose, the pitting apparatus has a turntable on which beaker-like cavities for holding a part of the olive are provided. The turntable positions the olives underneath a tappet device that pierces the pit out of the olive. During this piercing, the olive is pressed into the beaker-like cavity by the tappet. A rubber-like holding apparatus fixes the olive in place during the piercing process.

An olive pitting apparatus is also described in U.S. Pat. No. 3,282,396 A. The olives get into cavities, in such a manner that they are approximately held in position, comparable to egg cups. These cavities represent a lower part. An upper part is positioned above the cavities, in such a manner that the upper part, which is mounted on springs, aligns the olive within the cavity in such a manner that it can be pierced to remove the pit.

### Task of the Invention

In contrast, the invention is based on the task of developing a holder, a method, and a device for the treatment of drupes, particularly of pre-sorted raw olives, by means of which these can be pitted and filled industrially, in completely automated manner, and so that this is possible at high quality and low loss of fruit flesh.

### Solution for the Task

The solution for the task takes place, for one thing, in that at least the cavity sections in the upper part of the holding mold part have a flexible end to compensate for different natural lengths of the olives to be treated, and for another, by means of a method for treatment of drupes in accordance with claim 5, as well as a suitable device for this purpose, according to claim 9.

By means of a two-part structure, in which cavity sections that complement one another are situated in a lower part and an upper part, for holding the olives to be treated in a correct position, and by means of a flexible end of the cavity sections in the upper part of the holding mold part, in each instance, the circumstance was taken into account that the raw olives can have length tolerances of +/−5 mm, actually even of up to 10 mm, and therefore length equalization for the different olive lengths was created by means of the flexible end, in each instance, for example in the form of a silicone film. In this way, a holding mold part can be made available with which a greater number of olives, for example 10 to 100, can be positioned correctly for being processed together.

The method suitable for this, for simultaneous, common treatment of multiple olives, in which the holding mold part according to the invention can be used, which part passes through multiple work stations of a treatment device in this connection, is characterized in that in this method, the following work steps are carried out, one after the other:
the raw olives are laid into the cavity sections of the lower part of the holding mold part,
the raw olives are aligned and pitted in a pitting station,
the pitted olives are clamped in place by setting on the upper part of the holding mold part,
the two-part holding mold part is turned by 180°,
the pitted olives are filled, and, if necessary, sealed,
the two-part holding mold part is turned by 180°,
the upper part of the holding mold part is removed, and
the filled olives are removed from the mold.

At the beginning of the method according to the invention, the raw olives are individually laid, in known manner, for example by way of a mass funnel, onto a conveyor belt configured with drivers, and then pushed, standing in pre-centered manner, by portions, transverse to the belt, by means of transverse punches, by way of guide channels, into the cavity sections, in each instance, of the lower part of the holding mold part.

Alternatively, it can also be provided that the raw olives to be processed are fed onto a multi-track vibrating segment from a barrel, for example. The mass carpet of olives is conveyed forward automatically by way of the vibration grooves. In this connection, the olives are isolated and aligned in the longitudinal direction, and run, by way of tracks, onto the subsequent second track that lies underneath. Subsequently, the olives are now conveyed further, in preferably V-shaped grooves, and isolated up to an olive single-cycle apparatus. The isolated olives then run further, by way of a drop tube, to a stop element that regulates the olive backup accordingly. Then, one olive, in each instance, is passed through to a second stopper. As soon as the mold cavity under the second stop element is in position, the isolated olive is allowed into the mold cavity. The process is repeated until the cavity is filled. Filling can also take place in multiple rows.

Afterward, the mold part filled with raw olives in this manner gets to the pitting station, where the olives, which are only pre-centered at first, are aligned vertically in their standing position, before being pitted; specifically, for this purpose, a tool unit disposed above the olives is lowered, which tools have rotating sleeves configured in funnel shape and spring-mounted on their end sections, in accordance with the number of olives, which sleeves are pushed over the pre-centered olives. In this connection, the possible length differences of the raw olives are compensated by way of the spring path of the rotating sleeves. Afterward, the rotating sleeves turn, and automatically set the longitudinal axes of the raw olives upright and position them for the actual pitting process, which can thereby take place with as low a loss as possible, with regard to the olive substance.

During pitting itself, a vertical punch in the form of three spring-mounted needles penetrates into each raw olive from above, and, opposite to these, an also spring-mounted, rotating cutting sleeve penetrates into each olive from below, specifically in such a manner that first, the three needles penetrate all the way to the pit, and thereby hold it, and then the cutting sleeve moves upward until the olive pit is surrounded or cut out by it.

Subsequently, the olive pit is then ejected downward through the cutting sleeve, controlled by the three needles. After that, the vertical punches and the cutting sleeves move apart again into their respective starting position, and the pitting process has therefore been concluded. The clean filling opening that has thereby been formed in the lower region of the olives, which have now been pitted, offers an optimally controllable cavity volume for the later filling process, whereby it is advantageous that at the top of the olive, only three small punctures caused by the needles are visible, which do not, however, impair the later filling process. Finally, the olive pits obtained are collected in barrels, as a valuable material, and sold to olive-oil producers.

Optionally, it is also possible that at least one cutting sleeve is configured so as not to rotate.

If—depending on the cutting result—it is necessary to remove residues of pitted olives from the rotating sleeve or to avoid that a pitted olive remains hanging on when the sleeve is removed, it is proposed to provide the rotating sleeve with a spring-mounted ejector, so that the olive is ejected, in each instance.

Alternatively to this, it is provided to use a punch for ejection of the pit in place of the needles. Preferably, this can be a punch having a star-shaped or Philips-type die.

After pitting, the lower part of the holding mold part, filled with the pitted olives, is pushed into an application station where it is fixed in place with the corresponding cavity sections, by means of setting on the upper part, and, in this connection, at the same time the upper part and lower part are held together by means of integrated magnets.

Because, in this connection, the cavity sections of the upper part are delimited, toward the outside, by means of a thin, stretchable film, in such a manner that after the mold support has been closed, natural length differences between the pitted olives can be compensated by means of the stretchable film, these olives are thereby gently pressed against the lower part of the mold support, with their pitted opening that serves as a filling opening, and thereby positioned for this purpose.

In order to now be able to fill the pitted olives, a turning station follows, where the closed holding mold part is turned by 180°, so that the filling opening points upward. In this position, the holding mold part moves into a filling station, where a lance of a metering apparatus is immersed into the filling openings, in each instance, and these are filled according to what is called the one-shot method. What is called the two-layer method is also possible for this purpose. In this way, it is possible to obtain tasty new types of premium products (for example with liquid or creamy paste-like fillings). Alternatively, pressure metering systems or screw metering systems can also be integrated into the production line, specifically for filling more viscous filling viscosities, such as cheese paste fillings, for example.

If necessary, a device for applying a closing agent, such as a pectin droplet, can also be provided in the region of the filling station, whereby then, the filled olives still pass through a cooling tunnel, where the closure droplet is cooled, so that the filled olives are cleanly sealed.

The finished holding mold part is then transported to a further turning station, where it is turned once again by 180°, in other words turned over, so that in the subsequent removal station, the upper part of the holding mold part is removed again and can be passed back to the application station.

The filled olives are then automatically removed from the mold in a final unmolding station, and then transported further to a customer-specific final packaging line.

Further details and advantages of the present invention will be described and explained in greater detail below, using the drawings.

### DRAWINGS

These show:

FIG. 1 in a perspective view, a closed holding mold part consisting of a lower part and an upper part,

FIG. 2 an enlarged sectional representation according to a section line II-II in FIG. 1,

FIG. 3a a side view of the holding mold part according to FIG. 1, partly in section, along with a frontal view,

FIG. 3b a top view of the holding mold part according to FIG. 3a, along with a sectional representation through the region of a cavity for holding olives,

FIG. 4a a perspective representation of a device for automatic pitting and filling of olives,

FIG. 4b a detail from the device according to FIG. 4a in the region of a feed and laying-in station,

FIG. 4c a schematic representation of the sequence of a process of laying a raw olive into the lower part of the holding mold part of the device according to FIG. 4a,

FIG. 4d a schematic representation of the sequence of a centering process with subsequent pitting process in the pitting station of the device according to FIG. 4a,

FIG. 4e an enlarged sectional representation of a metering device for filling pitted olives according to the filling station in the device according to FIG. 4a, and

FIG. 4f an enlarged detail of the holding mold part according to FIG. 1 with an olive filled in the filling station according to the device according to FIG. 4a.

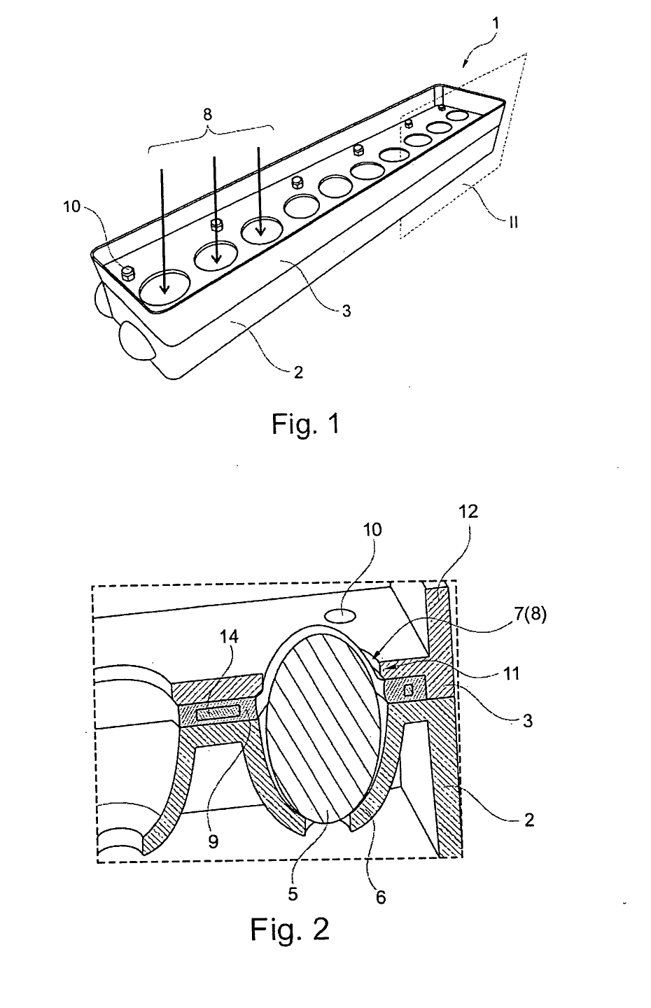

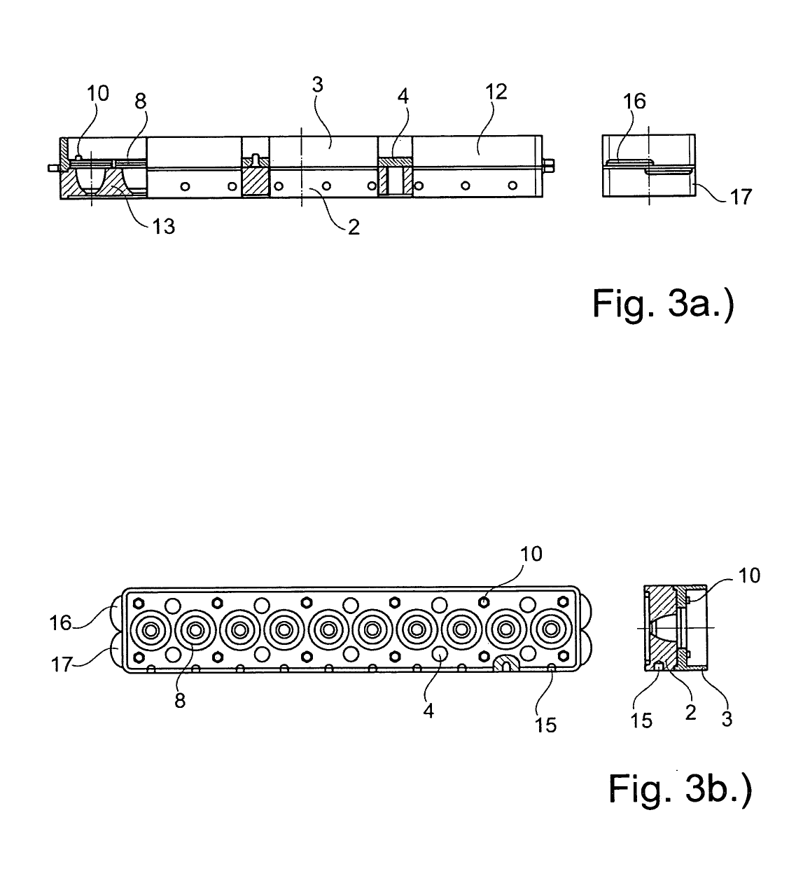

The holding mold part shown in perspective in FIG. 1—referred to with 1—consists of a box-shaped lower part 2 and a box-shaped upper part 3, which are releasably held together by means of ten integrated magnets 4 (FIG. 3a). Between the lower part and upper part 2, 3, ten cavity sections 6 and 7, which complement one another, are also provided, for correct positioning of raw olives 5 (FIG. 2), of which sections the cavity sections 7, provided in the upper part 3, are formed by a flexible end 8, in each instance, so that in the case of different natural lengths of the olives to be treated, these can be compensated. The ends 8 are parts of a film insert 9 configured to be flat, which is attached to the underside of the upper part 3 by means of screws 10, and can stretch upward, through a bore 11, in each instance, in accordance with the size of an olive.

For this purpose, the film insert 9 consists of a flexible silicone material, whereby a rubber is also possible for this purpose. The upper part 3 is configured in bowl shape on its top, as a sort of expansion space 12, whereas the underside of the lower part 2 can be configured either also bowl-shaped, as in FIG. 2, or solid, as shown in FIG. 3a at 13.

The film insert 9 has a thickness of 0.25 mm in the regions of the flexible ends 8, and is otherwise provided with reinforcement inserts 14 between the cavity sections 7.

In the present exemplary embodiment, the two-part holding mold part 1 has a strip-shaped form with a row of the aforementioned ten cavities 6; 7, whereby such a mold part can simply also have multiple such rows for a higher throughput of the raw olives 5 to be treated, as will be shown later. Finally, the two-part holding mold part 1 consists of a plastic of the Makrolon® brand. For fixation of the holding mold part 1 during a work process, this part possesses multiple countersunk bores 15 that are affixed on the longitudinal side of its lower part 2. Furthermore, the holding mold part 1 possesses gripping disks 16 and 17 on its two face sides, in the shape of circle segments, which project on half the side and are disposed offset from one another in height, with which it is more easily possible to remove the upper part 3 from the lower part 2 again, counter to the holding force of the magnets 4.

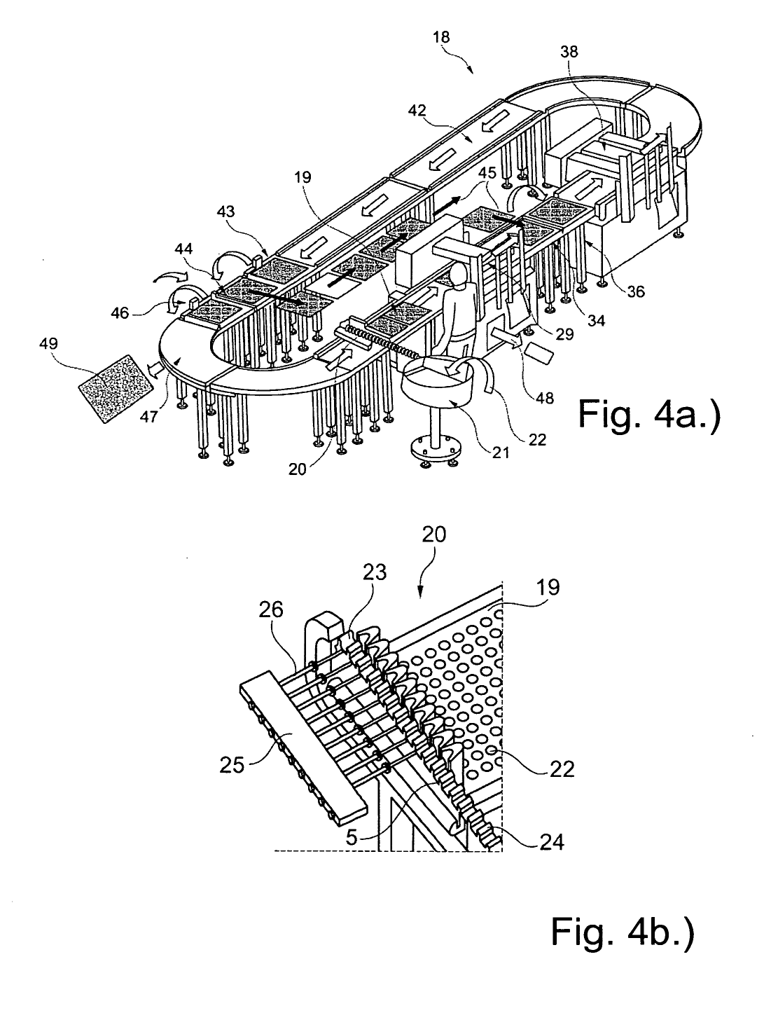

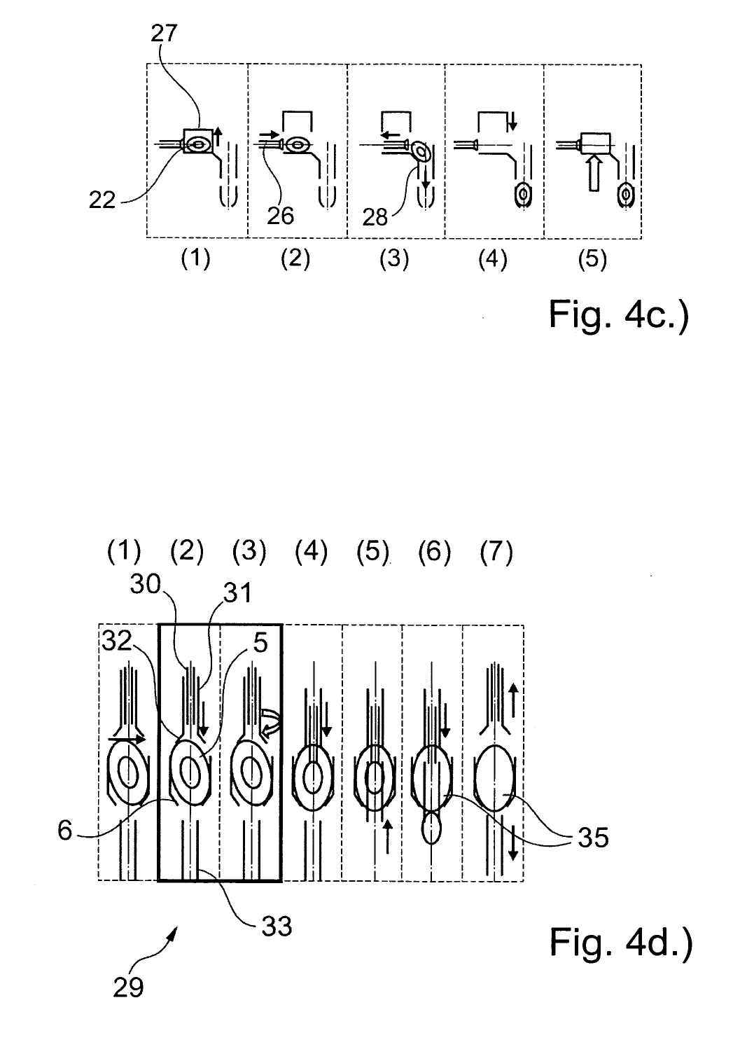

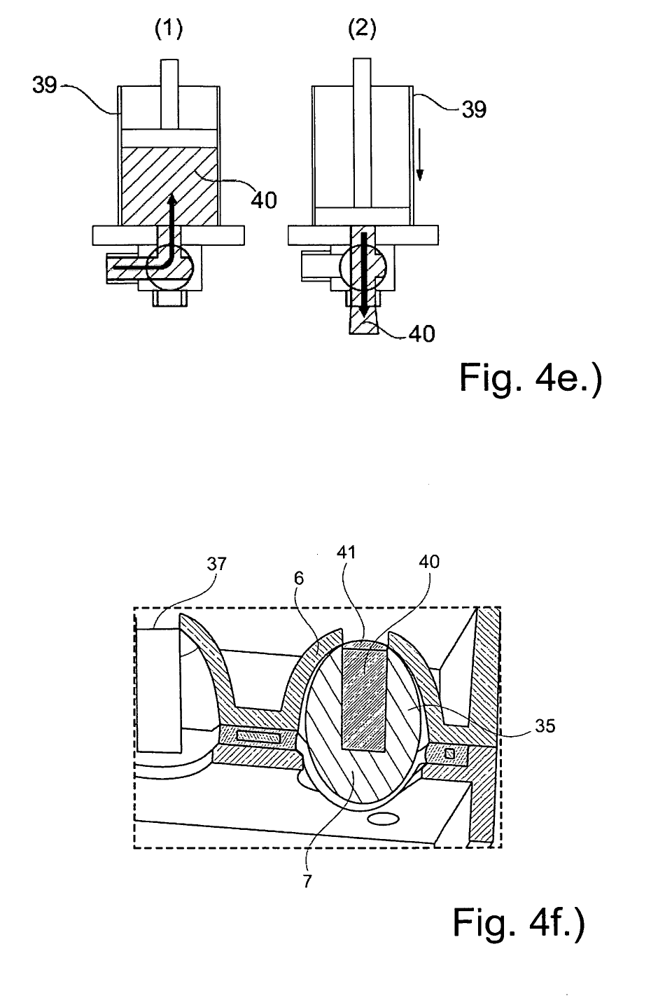

The device for automatic pitting and filling of raw olives 5—indicated with 18—shown in FIG. 4a to f has a modular structure, which offers the advantage that this device can easily be designed in accordance with customer-specific requirements. In the device 18, it is provided, as an example, that the holding mold part 1 is used in enlarged form, as a holding mold part 19 with 10 olives/row×10 rows=100 olives, whereby the throughput of olives in the device 18 can be significantly increased. In this connection, the functionally important parts of the smaller holding mold part 1 have been transferred to the larger holding mold part 19, and therefore have the same reference symbols as the holding mold part 1.

In detail, the device possesses the following work stations, disposed one behind the other:

As a first station, the device 18 possesses a feed and laying-in station 20, which has a mass funnel 21 that is filled with raw olives 5, pre-sorted with regard to their diameter, according to an arrow 22.

From this funnel, the pre-sorted raw olives 5 are passed on to a conveyor belt 24 provided with drivers 23 that follow one another, which belt has a transverse punch 25 with ten individual punches 26 standing opposite it, whereby the individual punches 26 are disposed at a distance, in each instance, corresponding to the interstices between the drivers 23 of the conveyor belt 24.

Furthermore, the feed and laying-in station 20, as shown in FIG. 4c, possesses a strip 27 that is lid-shaped or hat-shaped in cross-section, which strip covers a row of ten raw olives 5 on the conveyor belt 24, in each instance, in order to then release them again when a stroke of the individual punches 26 occurs, so that these convey the ten raw olives 5, in portions, simultaneously, in each instance, into a funnel-like guide 28 that faces downward, into the cavity sections 6 of the lower part of the holding mold part 19 (FIG. 4b), as is clearly illustrated in FIG. 4c with the steps 1 to 5.

The holding mold part 19, filled with the raw olives 5, then gets into a pitting station 29, which, as shown in the detail in FIG. 4d (process steps 1 to 7), possesses vertical punches—cycled in accordance with the number of raw olives 5—or per row and then advancing per row—in the form of three spring-mounted needles (alternatively a defined punch shape), which are surrounded by a rotating sleeve 31 that can be moved coaxial to the needles, having a funnel-shaped discharge 32, which serves for centering of the raw olives 5.

Below each vertical punch 30, a cutting sleeve 33 that is also spring-mounted and also has a rotational drive is provided, which sleeve is used with an upward movement in the opposite direction to the vertical punch 30.

After that, an application station 34 follows (FIG. 4a), where the upper part 3 is set onto the lower part 2 containing the pitted olives—now referred to as 35—of the holding mold part 19, which station is then followed by a turning station 36, with which the closed holding mold part 19 is turned by 180°, specifically so that the pitted olives 35 are directed upward with their filling opening 37, in each instance (FIG. 4f), for filling.

Then a filling station 38 follows, in which high-quality pumpable fillings 40 containing the finest ingredients (cheese, paste, etc.) are filled into the olives 35, using what is called the one-shot method, by means of filling lances, using a usual metering apparatus 39 (FIG. 4e, process steps 1 and 2). Alternatively, what are called two-layer methods are also possible for this purpose.

In addition, in the region of the filling station 38, an apparatus can be provided for closing the filling opening 37, which apparatus closes the filling opening 37 by means of a closing agent 41, such as a pectin droplet. Also, a cooling segment, for example in the form of a cooling tunnel, is then possible.

Furthermore, a holding mold part transport segment 42 follows, all the way to a further turning station 43, in which the holding mold part 19 containing the filled olives is turned by 180° once again, in order to be able to remove its upper part 3, which is then done by means of a subsequent removal station 44. In this connection, subsequently its return to the application station 34 takes place—as indicated by the arrow 45. Finally, an unmolding station 46 for the filled olives and a return of the empty lower parts 2 to the feed and laying-in station 20 takes place—as indicated by the arrow 47.

Proceeding from the device 18 for treating raw olives 5, such as pickling, pitting, as well as pitted olives 35, such as filling and unmolding, as shown in FIG. 4a-e, first the raw olives 5, pre-sorted by diameter sizes, are introduced into the holding mold part 19, in the correct position, within the feed and laying-in station 20.

This is done in such a manner that the raw olives 5 are passed to the conveyor belt 24, by way of the mass funnel 21, and then laid from the belt, in portions, in other words always by ten, in the present exemplary embodiment, into the cavity sections 6 of the first row of the lower part 2 of the holding mold part 19, in each instance, by means of the transverse punch 25, standing pre-centered in accordance with the sequence shown schematically in FIG. 4b, whereby afterward, the holding mold part 19 is moved further, row by row, in cycles, until it is completely filled with 100 raw olives 5.

The filled holding mold part 19 is then transported further to the pitting station 29, whereby at the same time, an empty holding mold part 19 moves into the feed and laying-in station 20, in order to be filled with raw olives 5. In the pitting station 29, the raw olives 5 are then first aligned to stand perpendicular, by means of the funnel-shaped discharges 32 of the rotating sleeves 31 that move down, specifically in that every discharge 32 is pushed over the upper part of the raw olive 5, in each instance, with a simultaneous rotational movement. This sequence corresponds to the schematic representation 2 and 3 of the detail according to FIG. 4d. Then, the vertical punches 30, in each instance, penetrate into the raw olives 5 with their three needles, all the way to their olive pit, so that the latter is thereby held, and afterward the cutting sleeves 33, which are coupled with a rotational drive, move upward, in the opposite direction, until the olive pits, in each instance, have been surrounded by them, in other words cut out. Then the olive pits are ejected, in each instance, through the cutting sleeve 33, by means of the three needles of the vertical punch 30 that is moving downward, in each instance, and collected as a valuable substance and disposed of, as is indicated by an arrow 48 in FIG. 4a.

This pitting process as described is reproduced in the schematic representations 4 to 6, according to the detail in FIG. 4d, whereby the last representation with the number 7 shows that afterward, the entire tools are moved back into their starting position.

After that, in the following application station 34, the pitted olives referred to as 35 are fixed in place, in that the upper part 3 of the holding mold part 19 is set onto its lower part 2, in centered manner. In this connection, the two parts are pulled against one another by means of the magnets 4 and thereby held together. At the same time, the natural length differences between the pitted olives 35 are compensated by the stretchable film of the cavity sections 7 of the upper part 3 (FIG. 2), and the olives 35 are gently pressed against the lower part 2 of the holding mold part 19 and thereby positioned for the subsequent filling process. In order to allow a filling process from above, however, the complete holding mold part 19 is previously passed to the turning station 36, where it is turned by 180°, so that the filling openings 37 of the olives 35, in each instance, are directed upward (FIG. 4f). In this position, the holding mold part 19 moves into the filling station 38, and there the individual olives 35 are filled with a filling 40, using a metering apparatus 39 (FIG. e), specifically using what is called the one-shot method. In this connection, as shown in FIG. 4e, pump cylinders are used, which first draw in a filling mass, in portions, and then press it into the filling opening 37 of the olives 35, in each instance. Afterward, the filling 40 is also practically sealed with a closing agent 41 in the form of a pectin droplet (FIG. 4f).

The holding mold part 19 treated in this way then gets to the turning station 43, by way of the transport segment 42, at which station it is turned by 180° once again. In the subsequent removal station 44, the upper part 3 is removed, and then passed back to the application station 34, as shown by the arrow 45.

The opened lower part 2 of the holding mold part 19 with the finished olives is finally transported to the unmolding station 46, where these are unmolded and then passed to a suitable packaging station—indicated at 49—whereby at the same time, return of the empty lower part 2 of the holding mold part 19—as shown by the arrow 47—to the feed and laying-in station 20 takes place.

With the present invention, optimal positioning of the longitudinal axis of the olives during pitting is therefore guaranteed, so that it is possible, using the proposed, reliable pit ejection principle, that rejects amount to max. only 2% to 3% for a defined input material, which means a rejects reduction of approximately 10% as compared with conventional methods.

Furthermore, an industrial production possibility was created, which allows the producer to industrially produce high-quality filled olives with the most varied filling viscosities, starting from the calibrated raw olive all the way to use possibilities of the most modern filling metering systems. By means of the use of the holding mold parts 1 and 19 as described, in particular, optimal positioning of the olives by means of their flexible clamping in these is achieved, and, at the same time, olives in a greater lot size can be treated in multiple work stations, all the way to the end product.

In this way, last but not least, intermediate storage of pitted olives in salt water barrels in the producer countries can be eliminated; this necessarily leads to quality losses, such as increased water absorption and taking on foreign flavors caused by the salt brine.

1. Holding mold part (1; 19) for drupes, particularly for holding raw olives (5) for their treatment, such as pickling, pitting, and the like, wherein the holding mold part (1; 19) can be put together from an upper part and a lower part (2, 3), between which multiple cavity sections (6, 7) that complement one another for holding the olives (5) are provided, wherein at least the cavity sections (7) in the upper part (3) have a flexible end (8) to compensate for different natural lengths of the raw olives (5) to be treated, and thereby the end (8) of the cavity sections (7) in the upper part (3), in each instance, is formed by a flexible film insert (9) that consists of silicone, rubber, or the like.

2. Holding mold part according to claim 1, wherein the lower part and upper part (2, 3) of the holding mold part (1; 19) can be connected with one another by means of multiple magnets (4) integrated into it.

3. Holding mold part according to claim 1, wherein its lower part and upper part (2, 3) are configured, in each instance, in strip shape or plate shape, with a row or multiple rows of cavity sections (6, 7).

4. Holding mold part according to claim 1, wherein the top of the upper part (3) is configured in bowl shape, as an expansion space (12) for the flexible ends (8).

5. Method for treatment of drupes, particularly of olives, in which these, after pre-sorting, are passed to a device (18) having multiple work stations for work steps such as pickling, pitting, and filling, wherein multiple olives pass through all the work stations during their joint treatment, at the same time, in the correct position, in a common holding mold part (1; 19), wherein a two-part support having an upper part and a lower part (2, 3) is used as the holding mold part (1; 19), in which there are complementary cavity sections (6, 7) for holding the olives.

6. Method according to claim 5, wherein the two-part holding mold part (1; 19) passes through the following work steps in the device (18):
raw olives (5) are laid into the cavity sections (6) of the lower part (2) of the holding mold part (1; 19),
the raw olives (5) are aligned and pitted,
the pitted olives (35) are then clamped in place by setting on the upper part (3) of the holding mold part (1; 19),
the two-part holding mold part (1; 19) is turned by 180°,
the pitted olives (35) are filled, and, if necessary, sealed,
the two-part holding mold part (1; 19) is turned by 180°,
the upper part (3) of the holding mold part (1; 19) is removed, and
the filled olives are removed from the mold.

7. Method according to claim 5, wherein at least the cavity sections (7) of the upper part (3) are delimited, toward the outside, by means of a thin, stretchable film section as a flexible end (8) of a film insert (9), in such a manner that after the holding mold part (1; 19) has been closed, natural length differences between the olives (35) can be compensated by means of the stretchable end (8), and the olives (35) are thereby gently pressed against the lower part (2) of the holding mold part (1; 19) with their pitted opening that serves as a filling opening (37), and thereby positioned.

8. Method according to claim 5, wherein the pitted olives (35) are filled, by way of their filling opening (37), by means of a metering apparatus (39), according to the one-shot method or the two-layer method, and these are afterward sealed, if necessary, with a closing agent (41), such as a pectin droplet.

9. Device (18) for automatic treatment of drupes, particularly for pitting and filling of olives, wherein it has a modular structure and wherein a two-part holding mold part (1; 19) formed from an upper part and a lower part (2, 3) and held together by means of magnets (4) is used, in which the olives are held in the correct position, specifically within complementary cavity sections (6, 7), which have a flexible end (8) for compensation of different natural lengths of pitted olives (35), at least in the upper part (3), wherein the device has the following work stations, disposed one behind the other:
feed and laying-in station (20) for laying raw olives (5) into the lower part (2) of the holding mold part (1; 19),
pitting station (29),
application station (34) for laying the upper part (3) onto the lower part (2) of the holding mold part (1; 19),
turning station (36) for turning the holding mold part (1; 19) by 180°,
filling station (37) for the pitted olives (35), having a device, if necessary, for applying a closing agent (41) for them and a cooling segment for this purpose,
turning station (43) for turning the holding mold part (1; 19) by 180° once again,
removal station (44) for removing the upper part (3) of the holding mold part (1; 19) and return of the upper part (3) to the application station (34), and
unmolding station (46).

10. Device according to claim 9, wherein the feed and laying-in station (20) possesses a conveyor belt (24) provided with drivers (23) that follow one another, which belt has individual transverse punches (25) disposed transverse to it, at the distance of the interstices between the drivers (23), assigned to it.

11. Device according to claim 9, wherein the pitting station (29) has vertical punches (30) corresponding to the number of raw olives (5) to be pitted, in the form of at least three spring-mounted needles, which are surrounded, in each instance, by a rotating sleeve (31) having a funnel-shaped discharge (32), which can be moved coaxial to the needles, which sleeve serves for centering the raw olives (5).

12. Device according to claim 9, wherein the filling station (38) has vertically displaceable filling lances of a metering apparatus (39), corresponding to the number of pitted olives (35), with which the olives (35) can be filled through their filling openings (37), metered by means of corresponding devices, using the one-shot method or two-layer method.

13. Device according to claim 12, wherein an apparatus for closing the filling openings (37) by means of a droplet-shaped closing agent (41) and a subsequent cooling segment such as a cooling tunnel are provided.
